(19) United States
(12) Patent Application Publication
(10) Pub. No.: US 2019/0107380 A1
(43) Pub. Date: Apr. 11, 2019

(54) STRAIN MEASUREMENT ASSEMBLY

(71) Applicant: SIKORSKY AIRCRAFT CORPORATION, Stratford, CT (US)

(72) Inventor: Brandon M. Cerge, Palm Beach Gardens, FL (US)

(21) Appl. No.: 15/729,775

(22) Filed: Oct. 11, 2017

(51) Int. Cl. G01B 7/16; B64D 45/00

(52) U.S. Cl. CPC G01B 7/18; G07C 5/008; B64D 2045/0085; B64D 45/00

(57) ABSTRACT

A strain measuring assembly for measuring a strain of an element of interest includes a strain gage and a first set of wire connectors disposed on a carrier that is within 12 inches of the strain gage, the first set of wire connectors being configured to connect with lead wires from the strain gage. The assembly also includes resistance measuring circuitry disposed on the carrier and connected to the first set of wire connectors, the resistance measuring circuitry being configured to measure a resistance of the strain gage and to output a signal derived from the measured resistance. The assembly further includes a second set of wire connectors disposed on the carrier and connected to the resistance measuring circuitry, the second set of wire connectors being configured to connect with wires from an external device to output the signal to the external device.

### BACKGROUND OF THE INVENTION

Exemplary embodiments of the disclosure relate to strain gages and, more particularly, to an assembly of components for providing an output signal indicative of measured strain.

Aircraft development typically requires the application of strain gages to elements of interest in the aircraft such as structural elements in order to monitor the strain experienced by those elements. This enables engineers to determine if the elements of interest are designed to withstand loads they are subjected to during flight.

Accordingly, it is desirable to provide strain gage equipment that enables more accurate and reliable stain measurements along with reduced costs and installation time.

### SUMMARY OF THE INVENTION

Disclosed is a strain measuring assembly for measuring a strain of an element of interest. The strain measuring assembly includes: a strain gage; a first set of wire connectors disposed on a carrier that is within 12 inches of the strain gage, the first set of wire connectors being configured to connect with lead wires from the strain gage; resistance measuring circuitry disposed on the carrier and connected to the first set of wire connectors, the resistance measuring circuitry being configured to measure a resistance of the strain gage and to output a signal derived from the measured resistance; and a second set of wire connectors disposed on the carrier and connected to the resistance measuring circuitry, the second set of wire connectors being configured to connect with wires from an external device to output the signal to the external device.

Also disclosed is a method for measuring a strain of an element of interest. The method includes: applying a strain gage to an element of interest; connecting lead wires from the strain gage to a first set of wire connectors disposed on a carrier that is within 12 inches of the strain gage; connecting wires from an external device to a second set of wire connectors disposed on the carrier; and measuring a resistance of the strain gage and outputting a signal derived from the measured resistance to the external device using resistance measuring circuitry disposed on the carrier, wherein the resistance measuring circuitry is electrically connected to the first set of wire connectors and the second set of wire connectors.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts aspects of a strain measurement assembly disposed on an element of interest on an aircraft;

FIG. 2 depicts aspects of the strain measurement assembly; and

FIG. 3 is a flow chart for a method for measuring a strain of an element of interest.

### DETAILED DESCRIPTION

Referring now to the Figures, where the invention will be described with reference to specific embodiments, without limiting same.

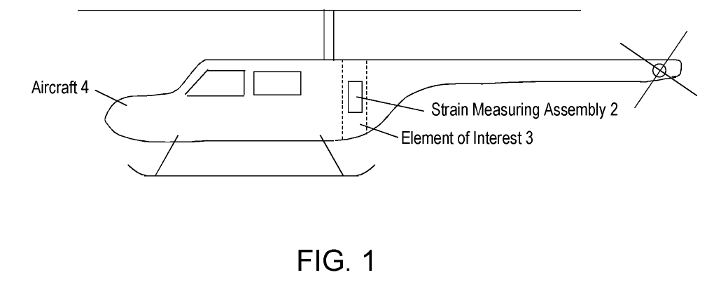

FIG. 1 illustrates a strain measuring assembly 2 disposed on an element of interest 3. In the embodiment of FIG. 1, the element of interest is part of an aircraft 4, which can be a rotary wing aircraft or fixed wing aircraft in a non-limiting embodiment. The element of interest can be static with respect to the aircraft, such as an airframe structural element or the element of interest can be dynamic with respect to the aircraft. The term “dynamic” relates to moving with respect to the aircraft such as for example having linear motion and/or rotating motion. The strain measuring assembly is configured to measure a strain of the element of interest upon which a strain gage of the strain measuring assembly is disposed. The strain measuring assembly is further configured to output a signal derived from the measured strain to an external device such as a data recorder. A user upon receiving the signal at the external device can then determine an amount of strain experienced by the element of interest over time. It can be appreciated that the strain measuring assembly 2 may also be used in other applications such as in other types of vehicles that may include spacecraft, land-craft and watercraft.

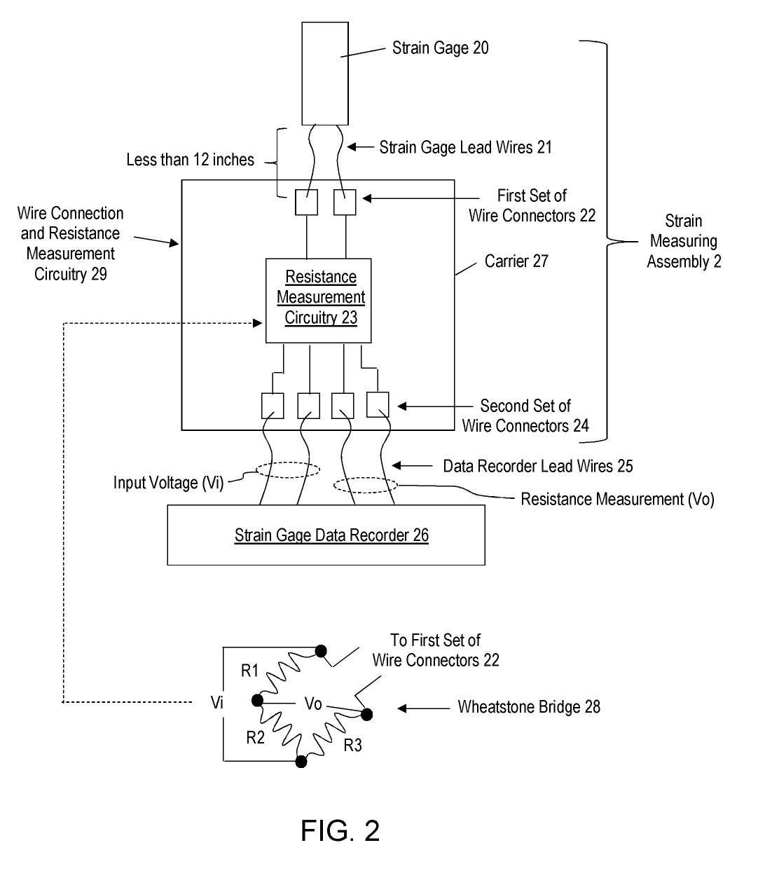

FIG. 2 depicts aspects of the strain measuring assembly 2. The strain measuring assembly 2 includes a strain gage 20. The strain gage 20 is configured to be disposed on the element of interest 3 and to measure a strain experienced by the element of interest 3. In general, the strain is imposed on a resistor such that the resistance value of the resistor provides indication of the imposed strain. Wire connection and resistance measurement circuitry 29 is disposed close to the strain gage 20 such as within 12 inches or within 4 inches of the strain gage 20. The wire connection and resistance measurement circuitry 29 is disposed on a carrier 27. In one or more embodiments, the carrier 27 is a fiberglass circuit board. Disposed on the carrier 27 is a first set of wire connectors 22. The first set of wire connectors 22 is configured to connect to strain gage lead wires 21 extending from the strain gage 20. In the embodiment of FIG. 2, there are two strain gage lead wires. In another embodiment, there can be more than two strain gage lead wires such as an additional wire in parallel with one of the lead wires in order to provide temperature compensation. In one or more embodiments, each of the wire connectors is a soldering pad, which may also be referred to as soldering tab. In one or more embodiments, the soldering pads are electroless nickel immersion gold (ENIG) plated for high reliability. In one or more embodiments, the strain gage lead wires 21 may have a gauge in the range of 28-32.

Resistance measurement circuitry 23 is also disposed on the carrier 27. The resistance measurement circuitry 23 is configured to measure a resistance of the strain gage 20. In one or more embodiments, the resistance measurement circuitry 23 is a Wheatstone bridge 28. Using the first set of wire connectors 22, the resistance of the strain gage 20, which is related to the measured strain, is connected to the resistance measurement circuitry 23. In the embodiment using the Wheatstone bridge 28, two resistors (R1 and R2) having known values are in a first leg and a third known resistor (R3) is in a second leg parallel to the first leg. The resistance of the strain gage 20 through a circuit in the first set of wire connectors 22 is provided to the second leg of the Wheatstone bridge 28. Input voltage (Vi) is provided to the Wheatstone bridge 28 and output voltage (Vo) provides a measurement of the resistance of the strain gage 20.

A second set of wire connectors 24 is further disposed on the carrier 27. The second set of wire connectors 24 is configured to connect with lead wires 25 to an external device such as a strain gage data recorder 26. In one or more embodiments, the external device provides the input voltage (Vi) and receives the output voltage (Vo), which may be referred to as an output signal. In one or more embodiments, the second set of wire connectors 24 may also be soldering pads or tabs and may also be ENIG plated. In one or more embodiments, the lead wires 25 may have a gauge in the range of 22-24.

It can be appreciated that the resistance measuring circuitry 23 and circuit connections to the first set of wire connectors 22 and the second set of wire connectors 24 may be embodied on the carrier 27 as a printed circuit with the carrier 27 being a printed circuit board.

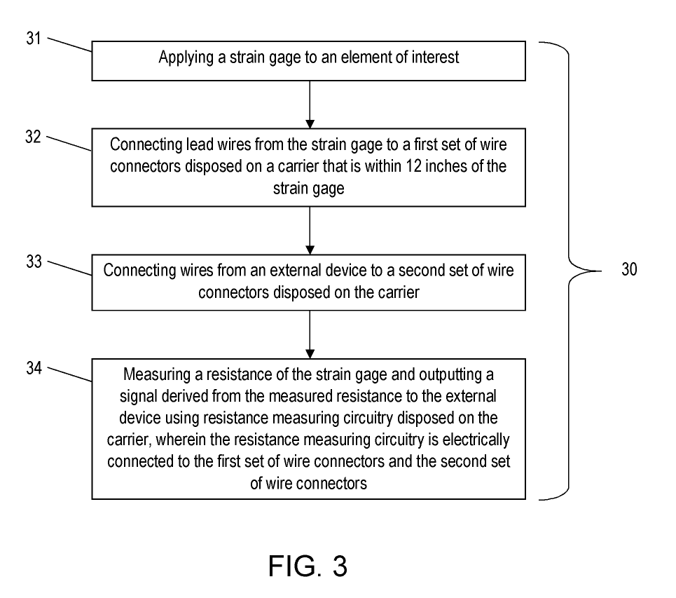

FIG. 3 is a flow chart for a method 30 for measuring a strain of an element of interest. Block 31 calls for applying a strain gage to an element of interest. In one or more embodiments the element of interest is in an aircraft. Block 32 calls for connecting lead wires from the strain gage to a first set of wire connectors disposed on a carrier that is within 12 inches of the strain gage. In one or more embodiments, this block may also include securing the carrier to the element of interest such as by an adhesive for example. Block 33 calls for connecting wires from an external device to a second set of wire connectors disposed on the carrier. In one or more embodiments, the external device is a strain gage data recorder configured to record measured strains over time from a strain gage. The strain gage data recorder may also include a power supply to provide an input voltage to resistance measuring circuitry. Block 34 calls for measuring a resistance of the strain gage and outputting a signal derived from the measured resistance to the external device using resistance measuring circuitry disposed on the carrier, wherein the resistance measuring circuitry is electrically connected to the first set of wire connectors and the second set of wire connectors. In one or more embodiments, the resistance measuring circuitry includes a bridge circuit such as a Wheatstone bridge.

The strain measuring assembly provides several advantages. One advantage is that by co-locating bridge completion circuitry (i.e., carrier and resistance measuring circuitry) next to the associated strain gage, the quality of the measured data increases because there is less chance of electrical interference. Another advantage is that the strain measuring assembly provides an increase in reliability and accuracy due to the carrier being made of a high temperature fiberglass and surface mount components such as resistors having low tolerances and being installed during a manufacturing process in a controlled environment. In addition, ENIG plated soldering pads or tabs provide for high reliability. Yet another advantage of co-locating bridge completion circuitry next to the associated strain gage is that the strain measuring assembly is less cumbersome and bulky and requires less real estate than conventional bridge completion circuitry not located with the strain gage resulting in the need for less material and fewer labor hours to fabricate and fewer labor hours to install.

Various other components may be included and called upon for providing for aspects of the teachings herein. For example, (1) mounting components or materials configured to mount the strain gage and/or the wire connection and resistance measurement circuitry, (2) strain data processing devices, and (3) telemetry for transmitting strain data may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first” and “second” are used to differentiate elements and do not denote a particular order.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

The disclosure illustratively disclosed herein may be practiced in the absence of any element which is not specifically disclosed herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A strain measuring assembly for measuring a strain of an element of interest, the strain measuring assembly comprising:
a strain gage;
a first set of wire connectors disposed on a carrier, the first set of wire connectors being within 12 inches of the strain gauge and configured to connect with lead wires from the strain gage;
resistance measuring circuitry disposed on the carrier and connected to the first set of wire connectors, the resistance measuring circuitry being configured to measure a resistance of the strain gage and to output a signal derived from the measured resistance; and
a second set of wire connectors disposed on the carrier and connected to the resistance measuring circuitry, the second set of wire connectors being configured to connect with wires from an external device to output the signal to the external device.

2. The strain measuring assembly according to claim 1, wherein the second set of wire connectors is further configured to provide an input voltage to the resistance measuring circuitry.

3. The strain measuring assembly according to claim 1, wherein the carrier is within four inches of the strain gauge.

4. The strain measuring assembly according to claim 1, wherein the first set of wire connectors and/or the second set of wire connectors comprise soldering pads.

5. The strain measuring assembly according to claim 1, wherein the carrier is a fiberglass printed circuit board.

6. The strain measuring assembly according to claim 1, wherein the resistance measuring circuitry comprises a Wheatstone bridge with the resistance of the strain gage being in one leg of the Wheatstone bridge via the first set of wire connectors.

7. The strain measuring assembly according to claim 1, wherein the external device is a strain gage data recorder.

8. The strain measuring assembly according to claim 1, wherein the lead wires from the strain gage comprise wire having a gauge in a range of 28-32.

9. The strain measuring assembly according to claim 1, wherein the wires from an external device comprise wire having a gauge in a range of 22-24.

10. The strain measuring assembly according to claim 1, wherein the element of interest is part of an aircraft.

11. A method for measuring a strain of an element of interest, the method comprising:
applying a strain gage to an element of interest;
connecting lead wires from the strain gage to a first set of wire connectors disposed on a carrier, the first set of wire connectors being within 12 inches of the strain gage;
connecting wires from an external device to a second set of wire connectors disposed on the carrier; and
measuring a resistance of the strain gage and outputting a signal derived from the measured resistance to the external device using resistance measuring circuitry disposed on the carrier, wherein the resistance measuring circuitry is electrically connected to the first set of wire connectors and the second set of wire connectors.

12. The method according to claim 11, further comprising inputting an input voltage to the resistance measuring circuitry via the second set of wire connectors.

13. The method according to claim 11, wherein the external device is a strain gage data recorder and the method further comprising recording strain measurements.

14. The method according to claim 11, wherein the element of interest is an aircraft.

15. The method according to claim 11, further comprising compensating for temperature using another lead wire in parallel with one of the lead wires from the strain gage.

16. The method according to claim 11, wherein the carrier is within four inches of the strain gauge.

17. The method according to claim 11, wherein the element of interest is part of an aircraft.
